(19) United States
(12) Patent Application Publication
(10) Pub. No.: US 2025/0089699 A1
(43) Pub. Date: Mar. 20, 2025

(54) TRIPPING IMPLEMENT FOR RODENT SNAP TRAP

(71) Applicant: David Schuelke, Park City, UT (US)

(72) Inventor: David Schuelke, Park City, UT (US)

(21) Appl. No.: 18/468,699

(22) Filed: Sep. 16, 2023

(51) Int. Cl. A01M 23/24; A01M 23/30

(52) U.S. Cl. CPC A01M 23/245; A01M 23/30

(57) ABSTRACT

An implement detachably affixable to the treadle of a standard snap trap adapted to increase sensitivity of the treadle to movement of a rodent, and thus increase sensitivity of the snap trap, and to increase the surface area of the treadle and bait engagement function thereof.

### FIELD OF THE INVENTION

This invention relates to rodent traps and more particularly relates to rodent traps adapted primarily for catching rats and mice.

### BACKGROUND

### Description of the Related Art

Snap traps for catching rodents, including mice and rats, are ubiquitous in the art since at least 1894. Rodent can destroy articles of food, books, furnishing, and homes. Rodents can carry diseases such as the hantavirus, and infestations may result in closure of commercial businesses. Rodents' gnawing, urine and feces can poison humans.

The traditional snap trap, or spring-loaded trap, is activated when bait placed on a treadle is moved by a rodent. When activated, a spring-biased, u-shaped bar is tripped and swing downwardly rapidly with great force, typically breaking a rodent's spinal cord or neck or skull.

Traditional rodent traps work well, but not perfectly. Snap traps suffer from a number of shortcomings, including mice approaching the trap laterally and flipping the trap over in the process of activating it. These snap traps are more effective if a rodent approaches the trap perpendicularly to the snap mechanism. Rodents can approach from the back of the trap and avoid the bar when it swings forward. Sometimes, a rodent will successfully remove bait from the treadle carefully such that the trap is not activated. The treadles in traditional mousetraps are small, and bait cannot easily be affixed to them.

Various inventors have attempted to create more efficient mousetraps, with differing measures of success.

More efficient trapping of rodents prevents entry of rodents into residential and commercial settings is desirable.

Traps are generally preferred as these are less hazardous to use around children and pets, but the snapping mechanisms incorporated into these traps can still harm children and domesticated animals and pets, such as dogs.

Because mice are caught by the trap, there is less chance of odor from mice dying in wall voids or other inaccessible areas after poisoning. Mousetraps in the form of wooden-based snap traps are common, but

Whilst recognizing the shortcomings of prior art mousetraps, the present inventor has sought to overcome these deficiencies with an implement which affixes to the treadle.

### SUMMARY

From the foregoing discussion, it should be apparent that a need exists for a tripping implement for a rodent snap trap. Accordingly, the present invention has been developed to provide a detachable tripping implement for improving sensitivity of a rodent trap, the implement comprising: a planar base plate defining a centrally-disposed slot adapted to receive a treadle of the rodent trap, the slot dimensions to contour an exterior surface of the treadle, the base plate having planar top surfaces and planar bottom surfaces; a plurality of protuberances jutting superiorly from the base plate adapted to secure bait; wherein the implement attaches to the treadle using a friction fit; wherein the implement is detachable from the treadle.

The protuberances may comprise loops. The detachable tripping implement may comprise four or more protuberances. The detachable tripping implement for improving sensitivity of a rodent trap may further comprise a centrally-disposed raised platform above the centrally-disposed slot in some embodiments.

A second detachable tripping implement for improving sensitivity of a rodent trap is provided, the implement comprising: a planar base plate defining a centrally-disposed slot adapted to receive a treadle of the rodent trap, the slot dimensions to contour an exterior surface of the treadle, the base plate having planar top surfaces and planar bottom surfaces; a plurality of loops jutting superiorly from the base plate adapted to secure bait; a centrally-disposed raised platform above the centrally-disposed slot; wherein the implement attaches to the treadle using a friction fit; wherein the implement is detachable from the treadle.

The detachable tripping implement for improving sensitivity of a rodent trap may further comprise four or more loops.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is an isometric, perspective view illustrating one embodiment of a tripping implement for a rodent snap trap in accordance with the present invention;

FIG. 1B is an isometric, perspective view illustrating one embodiment of a tripping implement for a rodent snap trap in accordance with the present invention;

FIG. 2 is an environmental, perspective view illustrating one embodiment of a tripping implement for a rodent snap trap in accordance with the present invention; and

FIG. 3 is an environmental, perspective view illustrating one embodiment of a tripping implement for a rodent snap trap in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided.

One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

It is an object of the present invention to provide an implement for improving function of a treadle in a traditional snap trap.

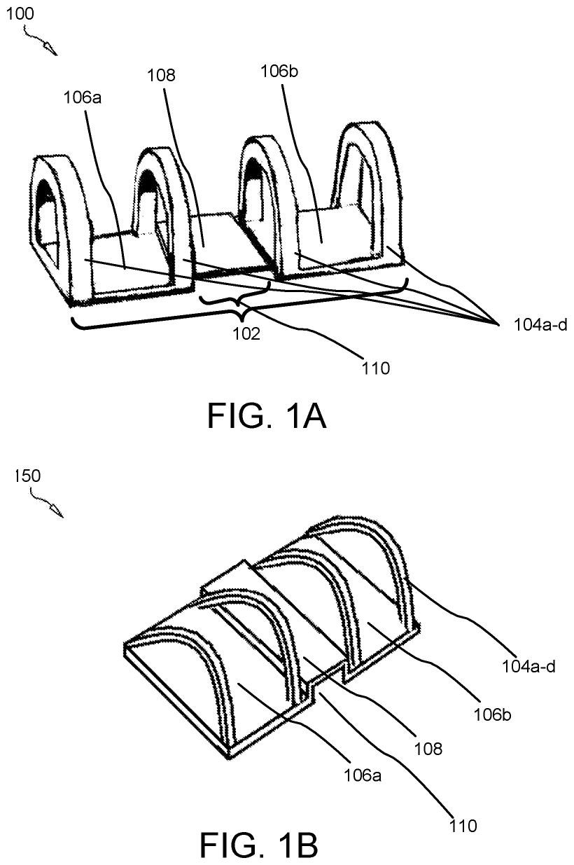

FIGS. 1A-1B illustrate isometric, perspective views of embodiments 100, 150 of a tripping implement for a rodent snap trap in accordance with the present invention.

The implement 100, 150 comprises a base plate 102 having planar sections on a bottom surface and planar sections 106 on a top surface. The baseplate 102, in some embodiments, defines a recess 110 centrally disposed on the bottom surface of the baseplate 102. The recess 110 may be termed a “slot” or “channel” into which the treadle 204 of a snap trap 202 positions or inserts. It is the lower surface of the baseplate 102 which is recessed forming the slot 110.

The implement 100, 150 is adapted to insert over or under the treadle 204. In various embodiments, the recess 110 contours an exterior surface of the treadle.

In various embodiments, the implement 100, 150 comprises a plurality of protuberances 104a-d, or loops 104a-d, or fasteners which jut superiorly from the top surface of the base plate 102. These loops 104 are adapted to provide improved securement function for bait, which may be pressed into the loops or placed inside of them. In various embodiments, these protuberances 104 may comprise hooks, barbs, shafts or other affixation means. The loops 104 extend from a forward edge of the baseplate 102 to a rearward edge of the same. The loops 104 may be arranged in parallel at regularly-spaced intervals across a breadth of the baseplate 102.

The implement 100, 150 may comprise a raised platform 108 with a raised planar surface above the recess 110. The entire width of the baseplate 102 is less than the with of a spring-loaded bar of the snap trap such that the spring-loaded bar falls around the baseplate 102.

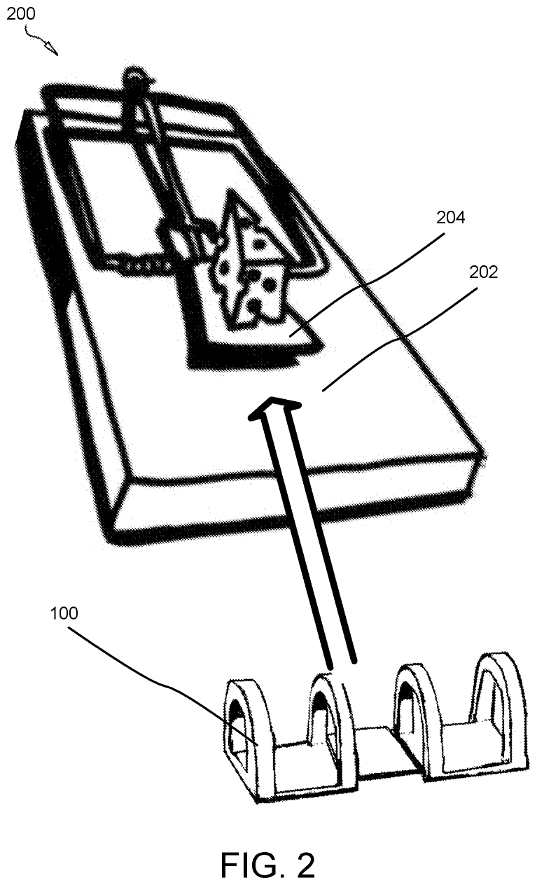

FIG. 2 is an environmental, perspective view illustrating one embodiment of a tripping implement for a rodent snap trap 200 in accordance with the present invention.

As shown, the implement 100 slides onto, beneath, around, or above the treadle 204 of the trap 202.

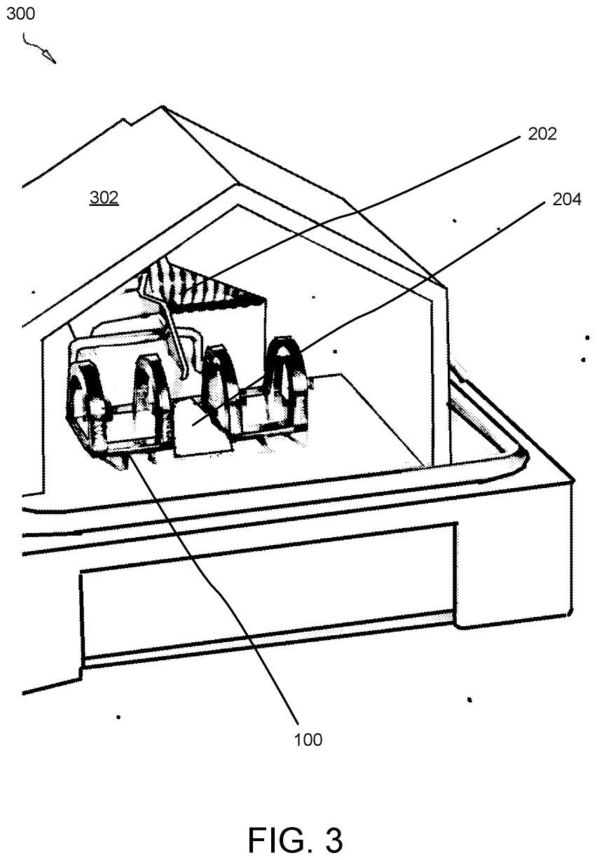

FIG. 3 is an environmental, perspective view illustrating one embodiment of a tripping implement for a rodent snap trap 300 in accordance with the present invention.

The trap 202 is positioned within a hood 302 which overlay the trap 202. The treadle 204 in this the shown embodiment is hook-shaped and the implement 100 is slide into the recess defined by the hooked treadle 204.

The implement 100, 300 may detachably affix to the treadle 204 using a friction fit. The implement 100, 300 is adapted to impart more sensitivity to the treadle and snap trap such that is triggers without affording a rodent as much flexibility in escape as a traditional snap trap.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A detachable tripping implement for improving sensitivity of a rodent trap, the implement comprising:
a planar base plate defining a centrally-disposed slot adapted to receive a treadle of the rodent trap, the slot dimensions to contour an exterior surface of the treadle, the base plate having planar top surfaces and planar bottom surfaces;
wherein the base plate is dimensioned to comprise a width more narrow than a spring-loaded bar of a snap trap to which the implement is affixed;
a plurality of protuberances jutting superiorly from the base plate adapted to secure bait, the loops are arranged in parallel and extend from a forward edge of the base plate to a rearward edge of the base plate;
wherein the implement attaches over treadle using a friction fit;
wherein the implement is detachable from the treadle.

2. The detachable tripping implement for improving sensitivity of a rodent trap of claim 1, wherein the protuberances comprise loops.

3. The detachable tripping implement for improving sensitivity of a rodent trap of claim 1, further comprising four or more protuberances.

4. The detachable tripping implement for improving sensitivity of a rodent trap of claim 1, wherein the planar base plate comprises a centrally-disposed raised platform above the centrally-disposed slot.

5. A detachable tripping implement for improving sensitivity of a rodent trap, the implement comprising:
a planar base plate defining a centrally-disposed slot adapted to receive a treadle of the rodent trap, the slot dimensions to contour an exterior surface of the treadle, the base plate having planar top surfaces and planar bottom surfaces;
a plurality of loops jutting superiorly from the base plate adapted to secure bait, the loops extending from a forward edge of the base plate to a rearward edge of the base plate;
wherein the base plate comprises a centrally-disposed raised platform above the centrally-disposed slot;
wherein the implement attaches to the treadle using a friction fit;
wherein the implement is detachable from the treadle.

6. The detachable tripping implement for improving sensitivity of a rodent trap of claim 1, wherein the plurality of loops comprises four or more loops.
